(19) United States
(12) Patent Application Publication
(10) Pub. No.: US 2026/0254905 A1
(43) Pub. Date: Aug. 27, 2026

(54) IMAGE FORMING APPARATUS AND ADJUSTMENT MARK

(71) Applicant: KONICA MINOLTA, INC., Tokyo (JP)

(72) Inventor: Kenji Okubo, Tokyo (JP)

(73) Assignee: KONICA MINOLTA, INC., Tokyo (JP)

(21) Appl. No.: 19/450,060

(22) Filed: Jan. 15, 2026

(30) Foreign Application Priority Data
Feb. 25, 2025 (JP) 2025-027517

(51) Int. Cl. H04N 1/00

(52) U.S. Cl. CPC H04N 1/0066; H04N 2201/0082

(57) ABSTRACT

An image forming apparatus includes a printing section that forms a printed image on a recording medium and a post-processing section that performs post-processing on the recording medium on which the printing section forms the printed image. Further, the image forming apparatus includes an adjustment chart generation section that generates, as an adjustment chart, a composite image having an adjustment mark for measuring a misregistration amount from a position of the post-processing. Still further, the image forming apparatus includes a post-processing setting section that adjusts a processing position of post-processing to be performed by the post-processing section, using the measured misregistration amount.

### CROSS-REFERENCE TO RELATED APPLICATION

The present application claims the benefit of priority to Japanese Patent Application No. 2025-027517 filed on February 25, 2025, the disclosures of all of which are hereby incorporated by reference in their entireties.

### Technical Field

The present invention relates to an image forming apparatus and an adjustment mark.

### Description of Related Art

Conventionally, an image forming apparatus is known that processes an imposition printed material such as a business card or a coupon (see, Japanese Patent No. 7517185, for example). In the image forming apparatus as described above, after a plurality of printed images are printed, post-processing such as cutting is performed by a trimmer unit (hereinafter, also referred to as TU) in-line (in a printing process). In addition, reference lines serving as reference positions for cutting between the respective printed images and auxiliary lines parallel to the reference lines are drawn on the printed material. Thus, even if a cut surface overlaps with the reference line so that the cut surface disappears, misregistration (a misregistration amount, a misregistration direction and the like) can be detected based on the position of the auxiliary line.

As described above, the conventional image forming apparatus can adjust a post-processing position with high accuracy by using the reference lines and the auxiliary lines drawn on a recording medium even if there are influences such as a machine difference in each TU and a specification change of the printed material to be subjected to post-processing.

### Summary of the Invention

In the conventional image forming apparatus configured as described above, in a case where a cut position is generated outer side of the reference line, it is necessary to actually measure a length from the cut surface to the reference line. In contrast, a cutting position is generated inner side of the reference line, it is necessary to actually measure a length from the cut surface to the auxiliary line and subtract the length from a distance between the reference line and the auxiliary line.

There is also known an apparatus in which a scanner is installed after cutting step to automatically detect a misregistration amount. For example, one recording medium may be cut into a plurality of cards (business cards or the like). In such a case, depending on a pitch interval of a conveyance roller, the printed material which has become a small piece cannot be conveyed to a scanner position. Therefore, the misregistration amount cannot be automatically detected, and further improvement is required.

The present invention has been made in view of such a background, and an object of the present invention is to provide an image forming apparatus and an adjustment mark capable of easily adjusting a position of post-processing to a position of a reference line by manual measurement.

The above object of the present invention is achieved by the following configurations. That is, an image forming apparatus includes (1) a printing section that forms a printed image on a recording medium and a post-processing section that performs post-processing on the recording medium on which the printing section forms the printed image. The image forming apparatus includes an adjustment chart generation section that generates, as an adjustment chart, a composite image having an adjustment mark for measuring a misregistration amount from a position of the post-processing. The image forming apparatus includes a post-processing setting section that adjusts a processing position of post-processing to be performed by the post-processing section, using the measured misregistration amount.

(2) The image forming apparatus according to (1), wherein the adjustment chart generation section further combines the composite image with a reference line indicating a position of the post-processing.

(3) The image forming apparatus according to (1) can calculate the misregistration amount based on a dimension of a processing surface formed on the recording medium by post-processing.

(4) The image forming apparatus according to (3), wherein the adjustment chart generation section applies the composite image to a calculation method for calculating the misregistration amount based on the length of the processing surface.

(5) The adjustment mark used in the image forming apparatus according to (2) includes an arbitrary misregistration amount reference point on the reference line and an intersection at which a perpendicular line from the misregistration amount reference point intersects with a parallel straight line which is parallel to the reference line. The adjustment mark has a ratio set point. At the ratio set point, an extended line of an oblique side that increases a separation dimension on the parallel straight line from the intersection at a predetermined ratio according to a separation distance on the perpendicular line from the misregistration amount reference point intersects with the parallel straight line. Thus, the adjustment mark has a triangular shape.

(6) The adjustment mark according to (5), wherein the ratio set point includes a first ratio set point and a second ratio set point which are separated from the intersection in opposite directions.

(7) The adjustment mark according to (2), wherein the adjustment mark includes a plus area and a minus area that face each other with the reference line interposed therebetween, and the plus area and the minus area are different from each other in color and/or shade.

### BRIEF DESCRIPTION OF THE DRAWINGS

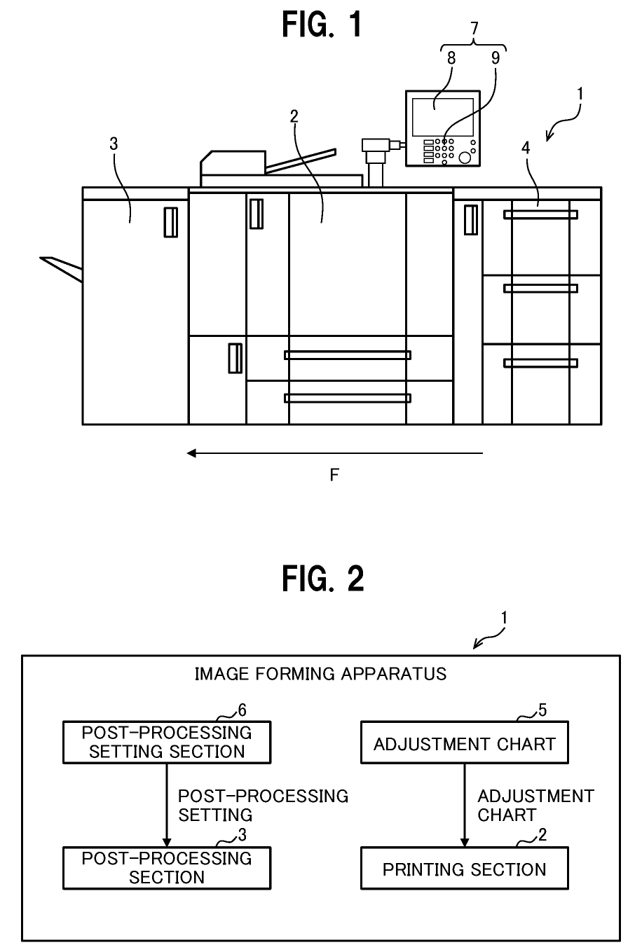

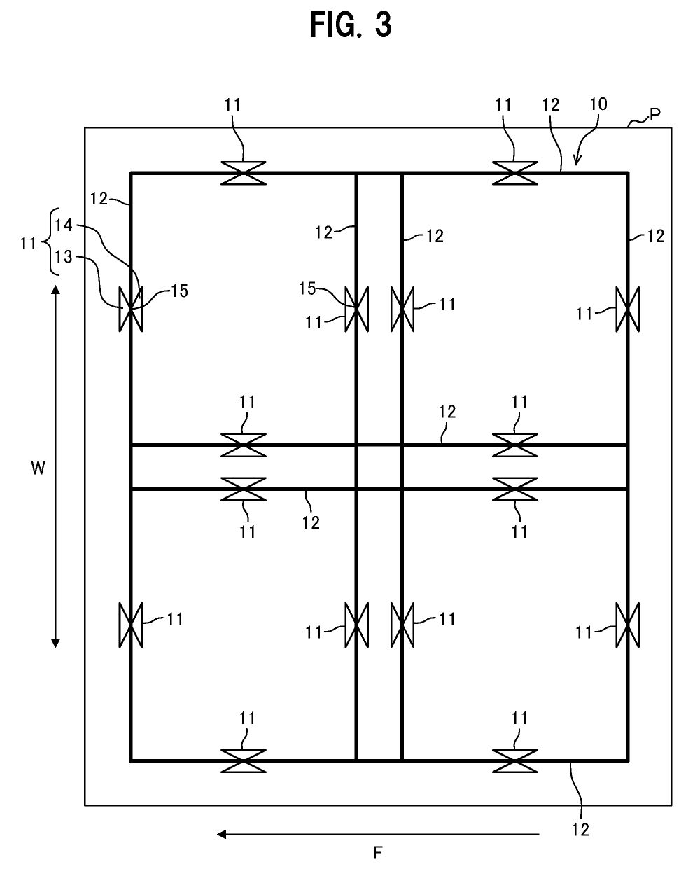

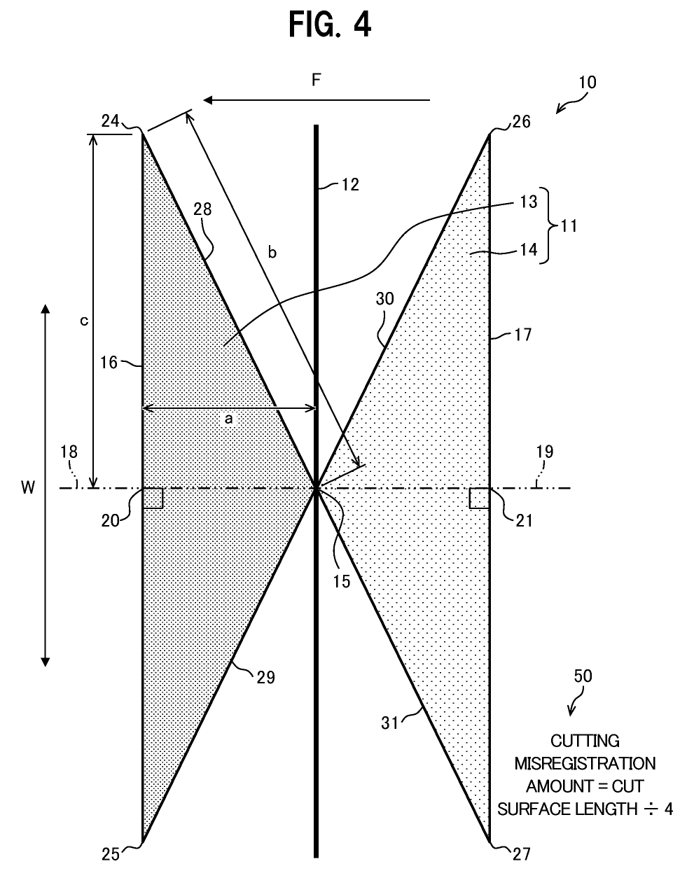

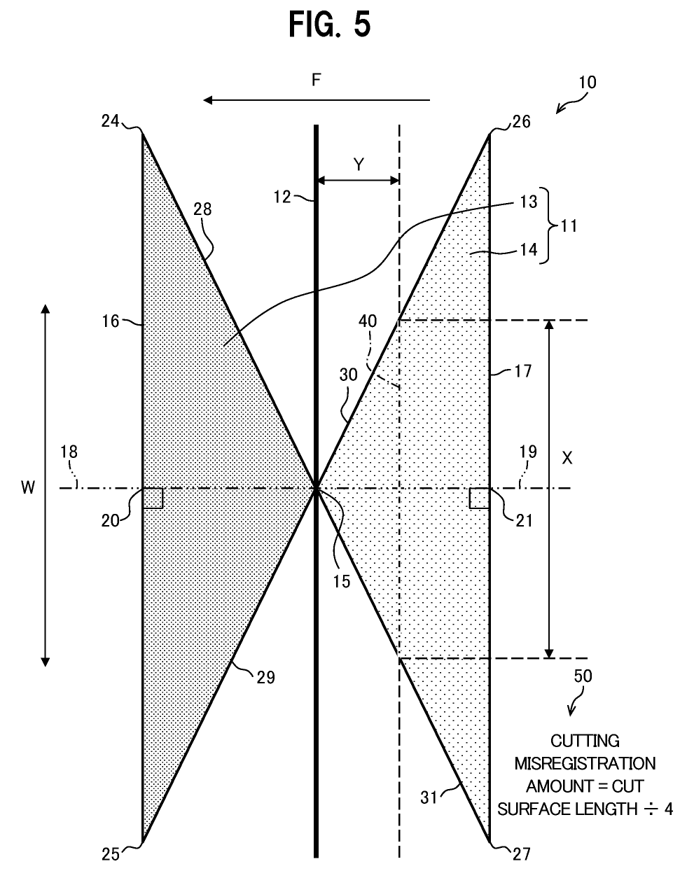

The advantages and features provided by one or more embodiments of the invention will become more fully understood from the detailed description given hereinbelow and the appended drawings which are given by way of illustration only, and thus are not intended as a definition of the limits of the present invention: FIG. 1 is a side view showing an entire configuration of an image forming apparatus of the present embodiment. FIG. 2 is a block diagram for explaining an inner configuration of the image forming apparatus. FIG. 3 is a plan view illustrating an example of a printed image printed on a recording medium. FIG. 4 is a plan view illustrating an example of an adjustment mark to be printed on the recording medium. FIG. 5 is a plan view of an adjustment mark for explaining a state of calculating a misregistration amount of a cut position.

### DETAILED DESCRIPTION

Hereinafter, a description will be given of a preferred embodiment of the present invention in detail with reference to accompanying drawings. However, the scope of the invention is not limited to the disclosed embodiment. In the specification and the drawings, constituent elements having substantially the same function are denoted by the same reference numerals, and redundant description thereof will be omitted. Here, for the purpose of explanation, a direction along a horizontal plane orthogonal to a conveyance direction F of a sheet is described as a width direction W. Further, in FIG. 1, a recording medium P during printing is not shown, and only the conveyance direction F of the recording medium P conveyed in the image forming apparatus 1 is shown by an arrow.

In the following, embodiments for carrying out the present invention will be described in detail with reference to the drawings.

FIG. 1 shows an image forming apparatus 1 according to the present embodiment. The image forming apparatus 1 includes a printing section 2 that forms a printed image on the recording medium P to create a printed material. The printing section 2 is connected to a sheet feed unit 4 which holds each of a plurality of recording medium (also referred to as media) P in a sheet feed tray on an upstream side in the conveyance direction F. Next, the printing section 2 prints the printed image on the recording medium P conveyed from the sheet feed unit 4, by an intermediate transfer method using electrophotography process technology.

That is, the printing section 2 primary transfers toner images of respective colors of yellow (Y), magenta (M), cyan (C), and black (K) formed on respective photoreceptor drums (not illustrated) onto an intermediate transfer belt. An image formed by superimposing the toner image in four colors is secondarily transferred to at least one of a front surface and a back surface of the recording medium P conveyed from a sheet feed tray, to form the printed image.

In addition, the image forming apparatus 1 includes a post-processing section 3 on a downstream of the printing section 2 in the conveyance direction F. The post-processing section 3 is configured to perform post-processing, such as cutting, on the recording medium P on which the printed image has been formed by the printing section 2. Further, the post-processing section 3 may include a sheet ejection unit having a plurality of sheet ejection trays in the conveyance direction F of the image forming apparatus 1. Next, the recording medium P subjected to post-processing such as cutting is carried out as a booklet or the like from the post-processing section 3.

Further, in the image forming apparatus 1 of the present embodiment, an operation panel 7 for inputting a misregistration amount measured by manual measurement and an image reading section for reading an image from an object to be copied such as a document are provided on an upper portion of a housing that houses the printing section 2.

The operation panel 7 is configured to allow the user to input the misregistration amount measured manually in order to adjust a processing position of the post-processing performed by the post-processing section 3.

The operation panel 7 of the embodiment includes a display part 8 such as a liquid crystal display (LCD) or an organic electro-luminescence (EL) display. Further, the operation panel 7 has an operation part 9 including various operation keys and the like with which an instruction from a user can be input as a numerical value or position information. Further, a part of the operation part 9 may be provided integrally with the display part 8 as a touch screen. The operation panel 7 sends input information input by the operation part 9 as an input signal to a controller described below.

Further, the operation panel 7 displays a setting screen for various operations on the display part 8, based on a display signal sent from the controller. The setting screen can display information for assisting input, such as a guide for setting a post-processing position. Note that as the operation part 9, other input devices such as a mouse and a tablet may be used, or both of them may be used.

The controller provided in the image forming apparatus 1 is connected to the operation panel 7, and is also connected to the printing section 2, the post-processing section 3, and the sheet feed unit 4.

The controller includes a central processing unit (CPU) and a read only memory (ROM). The controller further includes a storage device such as a random access memory (RAM) or a hard disk drive (HDD). The CPU reads a program corresponding to processing details from the ROM or the storage device, and develops in the RAM. Note that the storage device is not limited to an HDD. For example, the storage device may be formed by a recording medium such as a solid state drive (SSD) or a digital versatile disc (DVD)-ROM.

Next, the CPU cooperates with the developed program and various data stored in the storage section such as storage to control the printing section 2, the post-processing section 3, and the sheet feed unit 4 which constitute respective sections of the image forming apparatus 1.

For example, the user looks at the post-processing position setting screen displayed on the display part 8 of the operation panel 7 and presses an adjustment sheet output button of the operation part 9. Thus, the CPU of the controller controls the printing section 2 to print an adjustment chart 10 for adjusting the post-processing position on the recording medium P fed from the sheet feed unit 4.

The CPU of the controller is also configured to control the post-processing section 3 to perform specified post-processing, such as cutting, on the recording medium P conveyed from the printing section 2.

The image forming apparatus 1 according to the embodiment includes an adjustment chart generation section 5 that generates a composite image as adjustment chart, and a post-processing setting section 6 that adjusts the processing position of the post-processing to be performed by the post-processing section 3 by using the measured misregistration amount.

As schematically illustrated in FIG. 2, when the post-processing position is adjusted using the adjustment chart under the control of the controller, the adjustment chart generation section 5 that generates the composite image and the operation panel 7 provided in the post-processing setting section 6 are mainly used.

The adjustment chart generation section 5 generates the composite image as the adjustment chart 10.

The adjustment chart generation section 5 sends print image data of the adjustment chart including a plurality of adjustment marks 11 to the printing section 2. Then, the printing section 2 can print the adjustment chart 10 (see FIG. 3) on the recording medium P.

As illustrated in FIG. 3, the adjustment chart 10 includes a plurality of linear reference lines 12 indicating a position of the post-processing and a plurality of adjustment marks 11 for measuring a misregistration amount from the position of the post-processing.

The reference lines 12 are cutting lines along which an imposition printed material such as a business card or a coupon is cut and separated from the recording medium P.

In the embodiment, as illustrated in FIG. 3, "four side cutting" is performed will be described.

The "four side cutting" is one form of a cutting method for the recording medium P, and is stored in advance in the storage device or the like as information on cutting positions. In the "four side cutting", end portions of the recording medium P on four sides in the conveyance direction F of the recording medium P and the width direction W orthogonal to the conveyance direction are cut. Further, in the embodiment, slit cutting may be performed in the conveyance direction F and the width direction W of the recording medium P at the same time. Thus, the recording medium P (printed material) after cutting has a desired size. For example, the size of the recording medium P (printed material) after cutting is equivalent to a size of the business card or the like, and the recording medium P is separated into four small pieces.

However, there is a high possibility that the cutting lines overlap with the reference lines and the reference line disappears on the recording medium P after the cutting processing.

Therefore, conventionally, a method of printing a plurality of auxiliary lines parallel to the reference lines, such as a method of measuring the misregistration amount, has been known. For example, on the adjustment sheet S after the cutting process, there is a case where one auxiliary line positioned on the reference position side of the two auxiliary lines disappears and the other auxiliary line remains. In this case, it can be determined that the misregistration has occurred by the misregistration amount equal to or larger than a distance between the reference position and one of the auxiliary lines located on the reference position side and smaller than a distance between the reference position and the other auxiliary line.

In the conventional measurement method above, in a case where the cutting position is generated outside the reference line, it is necessary to actually measure a length from a cut processing surface to the reference line. In addition, in a case where a position of the processing surface is generated inside the reference line, it is necessary to perform calculation in which a length from the processing surface to the auxiliary line is actually measured and is subtracted from a distance between the reference line and the auxiliary line.

Therefore, it is necessary to actually measure the length from a cut surface to the reference line or the length from the cut surface to the auxiliary line and determine whether a calculation is made for the position adjustment value, which complicates adjustment work.

On the other hand, in the image forming apparatus 1 of the present embodiment, the adjustment chart 10 having the adjustment marks 11 as illustrated in FIG. 3 is printed on the recording medium P. In the adjustment chart 10, the reference lines 12 indicating positions where the post-processing is performed and adjustment marks 11 for measuring the misregistration amount from the position where the post-processing is performed are combined as a composite image.

The adjustment charts 10 are stored in advance as print data in the storage device for each size of the recording medium P or printed material.

In a measuring method for an adjustment value according to the embodiment, first, as a post-processing by the post-processing section 3, the recording medium P on which the adjustment chart 10 is printed is cut. Then, the user can easily calculate the misregistration amount based on a width dimension X of the portion overlapping the adjustment mark 11 in a processing surface 40 (see FIG. 5) cut in the post-processing.

The adjustment mark 11 of the embodiment is mainly configured to include a plus area 13 which is printed on an outer side of the printed material with respect to the reference line 12, and a minus area 14 which is printed on an inner side of the printed material with respect to the reference line 12 and is opposite to the plus area 13 with respect to the reference line 12 interposed therebetween.

The plus area 13 and the minus area 14 each have a shape of an isosceles triangle. The plus area 13 and the minus area 14 are printed to have a symmetrical shape in the front and rear with respect to the reference line 12 in the conveyance direction F, having an arbitrary misregistration amount reference point 15 provided on the reference line 12 as a common vertex and interposed therebetween.

Further, according to the embodiment, the plus area 13 has a plus-side intersection 20 and the minus area 14 has a minus-side intersection 21, respectively. At the intersections 20 and 21, a plus-side parallel straight line 16 and a minus-side parallel straight line 17 parallel to the reference line 12 intersect with perpendicular lines 18 and 19 extending from the misregistration amount reference point 15.

In the embodiment, a dimension of the perpendicular line 18 from the misregistration amount reference point 15 to the plus-side intersection 20 and a dimension of the perpendicular line 19 from the misregistration amount reference point 15 to the minus-side intersection 21 are configured to be the same length.

Further, the plus area 13 and the minus area 14 each have a plus-side ratio set point and a minus-side ratio set point, respectively.

The plus-side ratio set point in the embodiment includes a plus-side first ratio set point 24 and a plus-side second ratio set point 25 that are away from the intersection 20 along an extending direction of the parallel straight line 16 to opposite directions, respectively.

The minus-side ratio set point in the embodiment includes a minus-side first ratio set point 26 and a minus-side second ratio set point 27 that are away from the intersection 21 along an extending direction of the parallel straight line 17 to opposite directions, respectively.

Further, the triangles forming the plus area 13 and the minus area 14 have oblique sides 28, 29 and 30, 31, respectively. Furthermore, the triangles form the respective ratio set points where extending lines of the oblique sides 28, 29 and 30, 31 intersect with the parallel straight lines 16, 17.

In the embodiment, the plus-side first ratio set point 24 and the second ratio set point 25 increases respective separation dimensions from the intersection 20 in the opposite directions on the parallel straight line 16 at a predetermined ratio based on a separation distance on the perpendicular line 18 from the misregistration amount reference point 15.

Further, the minus-side first ratio set point 26 and the second ratio set point 27 increases respective separation dimensions from the intersection 20 in the opposite directions on the parallel straight line 17 at a predetermined ratio based on a separation distance on the perpendicular line 19 from the misregistration amount reference point 15.

The adjustment mark 11 of the embodiment is set such that, in the plus area 13 illustrated in FIG. 4, the ratio of the lengths of the sides of the triangle surrounded by the misregistration amount reference point 15, the intersection 20, and the first ratio set point 24 is set to be a:b:c = 1:√5:2.

In the plus area 13, the second ratio set point 25 of the embodiment is away from the intersection 20 by the same length in the opposite direction to the first ratio set point 24 in the width direction W.

In the minus area 14 illustrated in FIG. 4, the ratio of the lengths of the sides of the triangle surrounded by the misregistration amount reference point 15, the intersection 21, and the first ratio set point 26 is set to be 1:√5:2. Note that the ratio of each side of the triangle is not limited thereto.

In the minus area 14, the second ratio set point 27 of the embodiment is away from the intersection 21 by the same length in the opposite direction to the first ratio set point 26 in the width direction W.

Further, as illustrated in FIG. 4, the plus area 13 and the minus area 14 of the adjustment mark 11 are different in color and/or shade to each other. For example, the plus area 13 is colored in blue. The minus area 14 is colored in red.

Furthermore, the adjustment chart generation section 5 of the embodiment synthesizes the composite image with a calculation method 50 for calculating the misregistration amount based on the length of the processing surface 40 to generate the adjustment chart 10. The user refers to the calculation method 50 printed on the recording medium P to easily grasp the adjustment value.

In the embodiment, "cutting misregistration amount = cut surface length ÷ 4" is printed on the recording medium P as the calculation method 50. However, the present invention is not particularly limited thereto, and the adjustment chart 10 may be generated such that the calculation method 50 adapted to the ratio of each side of a triangle set in advance according to a type of the recording medium P or the printed material is synthesized and printed.

Accordingly, the user can recognize the adjustment value by referring to the processing surface 40. Then, the adjustment value can be manually input via the operation part 9 provided on the operation panel 7, and there is no need to perform automatic measurement.

Therefore, a scanner is not required in a step after cutting as in the related art, and the present invention can be applied to a printed material cut into a plurality of cards (business cards or the like).

In the image forming apparatus 1 of the embodiment configured as described above, when the adjustment sheet output button of the operation part 9 is pressed down, the controller controls the printing section 2 to print the adjustment chart 10 on the recording medium P.

In the adjustment chart 10 of the embodiment, the composite image is generated by combining the reference line 12 and the adjustment mark 11 having the plus area 13 and the minus area 14 at symmetrical positions on the opposite side with the reference line 12 interposed therebetween.

For example, when the post-processing section 3 cuts the recording medium P on which the adjustment chart 10 is printed, the processing surface 40 may be away from the reference line 12 by a predetermined misregistration amount Y to a front side or a rear side in the conveyance direction F.

FIG. 5 illustrates a case where the processing surface 40 is cut, being away rearward from the reference line 12 in the conveyance direction F by the misregistration amount Y. Note that the same applies to a case where the processing surface 40 is cut, being away forward in the conveyance direction F. Thus, the case where the processing surface 40 is positioned in the minus area 14 will be described, and the case where the processing surface 40 is positioned in the plus area 13 will not be described.

Regarding the adjustment marks 11 of the embodiment, the misregistration amount Y can be calculated from the width dimension X of the processing surface 40 formed on the recording medium P in the cutting step of the post-processing.

Specifically, the user actually measures the width dimension X in the width direction W included in the minus area 14 of the processing surface 40 cut in the post-processing by using a measuring tool such as a ruler while referring to the width dimension X.

At this time, an end face of the recording medium P such as paper serves as the processing surface 40. Therefore, it is sufficient to measure only the width dimension X of the processing surface 40 in a stable state along the end face, as compared with a case of actually measuring a length from the cut surface to the reference line in the direction substantially orthogonal to the processing surface as in the related art. Therefore, measurement accuracy is improved.

In the embodiment, when the processing surface 40 is positioned at the part of the adjustment mark 11 colored in blue, it can be determined that the cutting position is deviated frontward with respect to the reference line 12. In contrast, when the processing surface 40 is positioned at the part colored in red, it can be easily determined that the cutting position is deviated rearward with respect to the reference line 12. Further, even for a printed material, such as a business card, which cannot be conveyed because of its small size after cutting so that automatic measurement cannot be performed, it is possible to easily determine in which direction the printed material is deviated and to perform actual measurement.

Then, while referring to the calculation method 50 printed on the recording medium P, the user inputs an adjustment value, which is obtained by changing an actually measured width dimension X in the width direction W to 1/4, and an adjustment direction which is forward or backward, via the operation part 9 provided in the operation panel 7.

Therefore, accuracy of the adjustment value calculated based on the actual measured value is quadrupled.

Data of an adjustment value obtained by manual measurement through the operation panel 7 by operation of the user is input to the post-processing setting unit 6. The controller of the image forming apparatus 1 adjusts the cutting position performed in the post-processing section 3 using the input adjustment value.

Accordingly, the image forming apparatus 1 and the adjustment mark 11 of the embodiment can easily adjust the position of the processing surface 40 to be cut by the post-processing to the position of the reference line 12 by manual measurement.

Note that, in the embodiment, the case where the sheet is cut while the processing surface 40 is away rearward with respect to the reference line 12 by the misregistration amount Y in the conveyance direction F is illustrated with reference to FIG. 5, but the present invention is not particularly limited thereto.

For example, also in a case where the processing surface 40 is cut in a state of being deviated frontward in the conveyance direction F, the length of the processing surface 40 located in the plus area 13 is actually measured in a similar manner. Then, the adjustment value is input via the operation part 9 provided on the operation panel 7 so that the position of the processing surface 40 for the post-processing can be adjusted to the position of the reference line 12. Other configurations and advantageous effects are the same as those in the case where the processing surface 40 is deviated rearward to be located within the minus area 14 as illustrated in FIG. 5.

Though the embodiment of the present invention has been described above, the embodiment is merely an example and does not limit the technical scope of the present invention. The present invention can be applied to various other embodiments, and various changes such as omission and substitution can be made without departing from the scope of the present invention. The embodiments and modifications thereof are included in the range and scope of the invention described in the present specification and the like, and are also included in the invention described in the claims and the range of equivalents thereof.

For example, the adjustment mark 11 used in the image forming apparatus 1 of the embodiment includes the plus area 13 and the minus area 14, having different colors each other. However, the adjustment mark 11 is not particularly limited thereto. For example, the plus area 13 and the minus area 14 may be printed with different tint. That is, the plus area 13 and the minus area 14 have different in color and/or shade. Further, the sizes, the ratios of the sides, and the arrangement positions of the positive area 13 and the negative area 14 are not particularly limited.

For example, the ratio a:b:c of the sides of the triangle may be 1:1: √2 forming an isosceles right triangle. In this case, the calculation method for the adjustment value is Y = X/2. Alternatively, the adjustment mark 11 may be a triangle surrounded by the misregistration amount reference point 15, the intersection 21, and the first ratio setting point 26 in the minus area 14. Further, a triangle may be formed to be surrounded by the misregistration amount reference point 15, the intersection 21, and the second ratio setting point 27, or may be only one of them. In this case, the calculation method for the adjustment value is Y = X/2.

Further, in a case where the adjustment mark 11 is deviated from the reference line 12 only on one side in the front-rear direction, only one of the corresponding plus area 13 and the corresponding minus area 14 may be provided.

In the embodiment, as the post-processing performed in the image forming apparatus 1, the case where the cutting processing of the recording medium P is performed in the post-processing section 3 has been described. However, the post-processing is not particularly limited to the cutting processing. For example, perforation processing or folding processing may be performed as post-processing. That is, the post-processing needs only be performed on the recording medium P on which the printing section 2 has formed the printed image.

According to the present invention, the post-processing setting section 6 uses the manually measured misregistration amount to adjust a desired position for the perforation processing or the folding processing. In the manual measurement, the composite image having the adjustment marks 11 is used as the adjustment chart 10 so that the misregistration amount from the reference line 12 can be quickly and accurately grasped. Therefore, even when not only the cutting processing but also the perforation processing or the folding processing is performed, the position of the post-processing can be easily aligned with the position of the reference line. Accordingly, the present invention can exert practically advantageous effects that the quality of printed material can be further improved. Although the embodiment of the present invention has been described and illustrated in detail, the disclosed embodiment is made for purpose of illustration and example only and not limitation. The scope of the present invention should be interpreted by terms of the appended claims.

What is claimed is:

1. An image forming apparatus comprising:
a printing section that forms a printed image on a recording medium;
a post-processing section that performs post-processing on the recording medium on which the printing section forms the printed image;
an adjustment chart generation section that generates, as an adjustment chart, a composite image having an adjustment mark for measuring a misregistration amount from a position of the post-processing; and
a post-processing setting section that adjusts a processing position of post-processing to be performed by the post-processing section, using the measured misregistration amount.

2. The image forming apparatus according to claim 1, wherein the adjustment chart generation section further combines the composite image with a reference line indicating a position of the post-processing.

3. The image forming apparatus according to claim 1 which is capable of calculating the misregistration amount based on a dimension of a processing surface formed on the recording medium by post-processing.

4. The image forming apparatus according to claim 3, wherein the adjustment chart generation section applies the composite image to a calculation method for calculating the misregistration amount based on the length of the processing surface.

5. The adjustment mark used in an image forming apparatus according to claim 2, wherein the adjustment mark has a triangular shape having an arbitrary misregistration amount reference point on the reference line, an intersection at which a perpendicular line from the misregistration amount reference point intersects with a parallel line parallel to the reference line, and a ratio set point at which an extended line of an oblique side that increases a separation dimension on the parallel straight line from the intersection at a predetermined ratio according to a separation distance on the perpendicular line from the misregistration amount reference point intersects with the parallel straight line.

6. The adjustment mark according to claim 5, wherein the ratio set point includes a first ratio set point and a second ratio set point that are away from the intersection in opposite directions, respectively.

7. The adjustment mark used in an image forming apparatus according to claim 2, wherein the adjustment mark includes a plus area and a minus area that face each other having the reference line therebetween, and the plus area and the minus area are different from each other in color and/or shade.
